(19) United States
(12) Patent Application Publication
(10) Pub. No.: US 2014/0354033 A1
(43) Pub. Date: Dec. 4, 2014

(54) MINING PICKS AND METHOD OF BRAZING MINING PICKS TO CEMENTED CARBIDE BODY

(71) Applicant: DIAMOND INNOVATIONS, INC., Worthington, OH (US)

(72) Inventors: Thomas EASLEY, Bexley, OH (US); Douglas BACK, Buckeye Lake, OH (US)

(73) Assignee: DIAMOND INNOVATIONS, INC., Worthington, OH (US)

(21) Appl. No.: 14/289,765

(22) Filed: May 29, 2014

Related U.S. Application Data
(60) Provisional application No. 61/828,225, filed on May 29, 2013.

(51) Int. Cl. E21C 35/183; B23K 1/00

(52) U.S. Cl. CPC E21C 35/183; B23K 1/0008; E21C 2035/1803
USPC 299/113; 228/121

(57) ABSTRACT

A tool and a method of making the tool is disclosed. The tool comprises a sleeve and a compact. The sleeve may have a proximal end, a distal end, a central axis, and a bore extending from the proximal end to the distal end, the bore having an inner wall. The compact may have a base end and an impact surface spaced opposite to the base end. The compact may be substantially disposed within the bore of the sleeve. The proximal end may be disposed proximate the base end of the compact.

### CROSS-REFERENCE TO RELATED APPLICATIONS

This application claims the benefit of U.S. Provisional application No. 61/828,225, filed May 29, 2013.

### TECHNICAL FIELD AND INDUSTRIAL APPLICABILITY

The present invention relates generally to a superabrasive compact and its method of making, and more particularly, to a mining pick and method of brazing mining pick to cemented tungsten carbide body.

### SUMMARY

In one embodiment, a tool may comprise a sleeve having a proximal end, a distal end, a central axis, and a bore extending from about the proximal end to about the distal end, the bore having an inner wall; and a compact having a base end and an impact surface spaced opposite to the base end, wherein the compact is substantially disposed within the bore of the sleeve, wherein the proximal end of the sleeve is disposed proximate to the base end of the compact.

In another embodiment, a method comprises providing a sleeve having a proximal end, a distal end, a first central axis, and a bore; positioning the proximal end of the sleeve above the distal end of the sleeve; inserting a compact into the bore of the sleeve in such a way that a second central axis of the compact coincides with the first central axis of the sleeve; and brazing a plug into the compact and the sleeve.

In yet another embodiment, a tool comprises a sleeve having a proximal end, a distal end, a first central axis, and a bore; and a compact substantially brazed within the bore of the sleeve, wherein the compact has a second central axis, wherein the first and the second central axis coincide.

### BRIEF DESCRIPTION OF THE DRAWINGS

The foregoing summary, as well as the following detailed description of the embodiments, will be better understood when read in conjunction with the appended drawings. It should be understood that the embodiments depicted are not limited to the precise arrangements and instrumentalities shown.

FIG. 1a is a schematic front view of a compact with a sleeve and a plug according to an embodiment;

FIG. 1b is a schematic front view of a compact with a sleeve and a plug according to another embodiment;

FIG. 2a is a schematic front view of a sleeve and a plug according to an according to an embodiment;

FIG. 2b is a schematic front view of a sleeve and a plug according to another embodiment;

FIG. 3 is a schematic front view of a compact with a sleeve according to another embodiment;

FIG. 4a is a schematic top view of a sleeve according to an embodiment;

FIG. 4b is a schematic front view of a compact according to an embodiment;

FIG. 5 is a cross-sectional view of a sleeve, a compact, a braze metal and a support according to an embodiment;

FIG. 6 is a cross-sectional view of a sleeve, a compact, a braze metal and a support according to another embodiment;

FIG. 7 is a cross-sectional view of a sleeve, a compact, a braze metal and a support according to yet another embodiment;

FIG. 8 is a cross-sectional view of a sleeve, a compact, a braze metal and a support according to further another embodiment;

FIG. 9 is a cross-sectional view of a sleeve, a compact, a braze metal and a support according to still another embodiment; and

FIG. 10 is a flow chart illustrating a method of making a tool incorporating a mining pick and a sleeve according to an embodiment.

### DETAILED DESCRIPTION

Polycrystalline diamond composite (or “PDC”, as used hereafter) may represent a volume of crystalline diamond grains with embedded foreign material filling the inter-grain space. In one particular case, polycrystalline diamond composite comprises crystalline diamond grains, bonded to each other by strong diamond-to-diamond bonds and forming a rigid polycrystalline diamond body, and the inter-grain regions, disposed between the bonded grains and filled with a catalyst material (e.g. cobalt or its alloys), which was used to promote diamond bonding during fabrication. Suitable metal solvent catalysts may include the metal in Group VIII of the Periodic table. PDC cutting element (or “PDC cutter”, as is used hereafter) comprises an above mentioned polycrystalline diamond body attached to a suitable support substrate, e.g., cobalt cemented tungsten carbide (WC-Co), by the virtue of the presence of cobalt metal. In another particular case, polycrystalline diamond composite comprises a plurality of crystalline diamond grains, which are not bonded to each other, but instead are bound together by foreign bonding materials such as borides, nitrides, carbides, e.g. SiC.

Polycrystalline diamond composites and PDC cutters may be fabricated in different ways and PDC cutters may be coated via different methods. In one example, PDC cutters are formed by placing a mixture of diamond polycrystalline powder with a suitable solvent catalyst material (e.g. cobalt) on the top of WC-Co substrate, whose assembly is subjected to processing conditions of extremely high pressure and high temperature (HPHT), where the solvent catalyst promotes desired inter-crystalline diamond-to-diamond bonding and, also, provides a binding between polycrystalline diamond body and substrate support.

In another example, PDC cutter is formed by placing diamond powder without a catalyst material on the top of substrate containing a catalyst material (e.g. WC-Co substrate or an additional thin cobalt disk in contact with the diamond powder). In this example, necessary cobalt catalyst material is supplied from the substrate and melted cobalt is swept through the diamond powder during the HPHT process.

In still another example, a hard polycrystalline diamond composite is fabricated by forming a mixture of diamond powder with silicon powder and mixture is subjected to HPHT process. Under HPHT conditions, the silicon melts and reacts with diamond to form SiC, thus forming a dense polycrystalline cutter where diamond particles are bound together by newly formed SiC material. Diamond composites made using this method are often called “silicon carbide bonded diamond composites”.

Mining picks made from silicon carbide bonded diamond composites, such as Versimax (produced by Diamond Innovations, Inc., Worthington, Ohio), have been lab tested and shown to have superior performance to WC materials. In order to make tools, diamond inserts may be brazed into WC holders. Mining picks may be centered in WC holders to maintain an even braze joint around the entire circumference of the insert. Vacuum brazing, induction brazing, or furnace brazing may be used. PDC may be coated by metals, metal carbides, or mixtures of metal and metal carbides, or uncoated, depending on the needs of the chosen brazing method and brazing alloy.

In one embodiment, polycrystalline diamond composite may be encapsulated in a sleeve like a shell, such as a tungsten carbide sleeve, that is brazeable. The WC sleeve may have an angled part at the tip and a plug in the bottom holding the polycrystalline diamond securely in place. The tungsten carbide sleeve may have a bore, inside which there are a plurality of ridges to surround the polycrystalline diamond composite. The WC sleeve may have a cylindrical body. The diameter and angle of the WC sleeve may match the corresponding geometry of the polycrystalline diamond composite insert.

The WC sleeve may be placed on a support with the angled part down. The polycrystalline diamond composite may be inserted into the WC sleeve together with a braze metal and a plug. In another embodiment, the tungsten carbide sleeve may have a slit so that the polycrystalline diamond composite may be brazed into place as the tungsten carbide sleeve is compressed circumferentially, thus locking the sleeve onto the pick.

In yet another embodiment, a straight walled hollow WC sleeve with no angled part may be used. Various parts with machined holes or rings with angled part may be used as a method of aligning the polycrystalline diamond composite in the tungsten carbide. Such machined holes or rings may include drilled holes, for example. The various parts may be made of graphite, for example.

An assembly of the polycrystalline diamond composite, WC sleeve, braze metal, and WC plug may be placed in a furnace and heated to the braze temperature to melt the braze. When the braze is liquid, it may flow between all gaps between the polycrystalline diamond composite, WC sleeve, and the plug. The weight or pressure applied to the polycrystalline diamond composite and the angled portion of the WC sleeve maintain central alignment and equal braze joint thickness between the polycrystalline diamond composite and the WC sleeve.

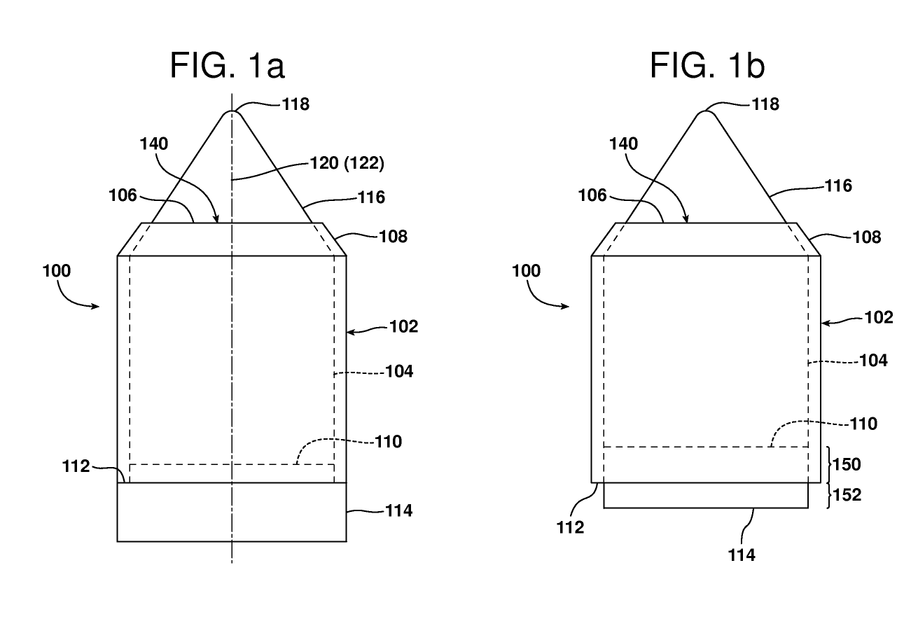

As shown in FIG. 1a, a tool 100 may comprise a sleeve 102 and a compact 104, such as polycrystalline diamond composite. The sleeve 102 may comprise a proximal end 112, a distal end 106, a first central axis 120 and a bore 140. The bore 140 may extend from about the proximal end 112 to about the distal end 106. The compact 104 may comprise a base end 110 and an impact surface 116 spaced opposite to the base end 110. The compact 104 may be substantially disposed within the bore 140 of the sleeve 102. The proximal end 112 of the sleeve 102 may be disposed proximate to the base end 110 of the compact 104. The compact 104 may be substantially brazed within the bore 140 of the sleeve 102. The compact 104 may have a second central axis 122. The first central axis 120 and the second central axis 122 may coincide.

The impact surface 116 may comprise a radiused tip 118. The radiused tip 118 may be substantially disposed outside of the bore 140 of the sleeve 102 when the compact 104 was inserted into the bore 140 of the sleeve 102. The sleeve 102 may have an angled part 108, angled toward the first central axis 120. The angled part 108 may help to hold the compact 104 from slipping out of the sleeve 102 when the sleeve 102 is put upside down with the angled part 108 pointing downward. The plug 114 may have same width as the sleeve 102 in one embodiment. In another embodiment, the plug 114 may have the same width as the compact 104 as shown in FIG. 1b so that a portion 150 of plug 114 may be inserted into the bore 140 of the sleeve 102. A portion 152 may be left protruded out of the bore 140 of the sleeve 102. The portion 152 may be ground off after finishing.

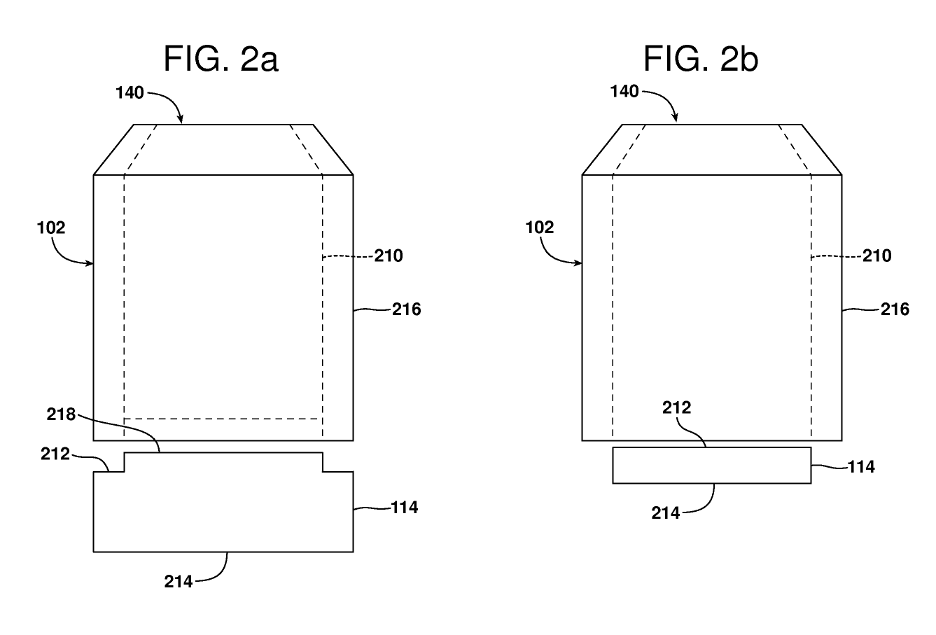

As shown in FIG. 2a, the sleeve 102 may further include an inner wall 210 and an outside surface 216. The plug 114 may include an upper surface 212 and a lower surface 214. The upper surface 212 may have a protrusion 218 so that the protrusion 218 may be inserted into the bore 140 of the sleeve 102. In another embodiment, the upper surface 212 may be flat and may not have the protrusion 218 as shown in FIG. 2b. The width of the upper surface 212 or the lower surface 214 may be the same as the width as the bore 140 of the sleeve 102 so that at least a part of the plug may be inserted into the sleeve 102. The plug 114 may be attached to the proximal end 112 of the sleeve 102 and the base end 110 of the compact 104 (shown in FIG. 1).

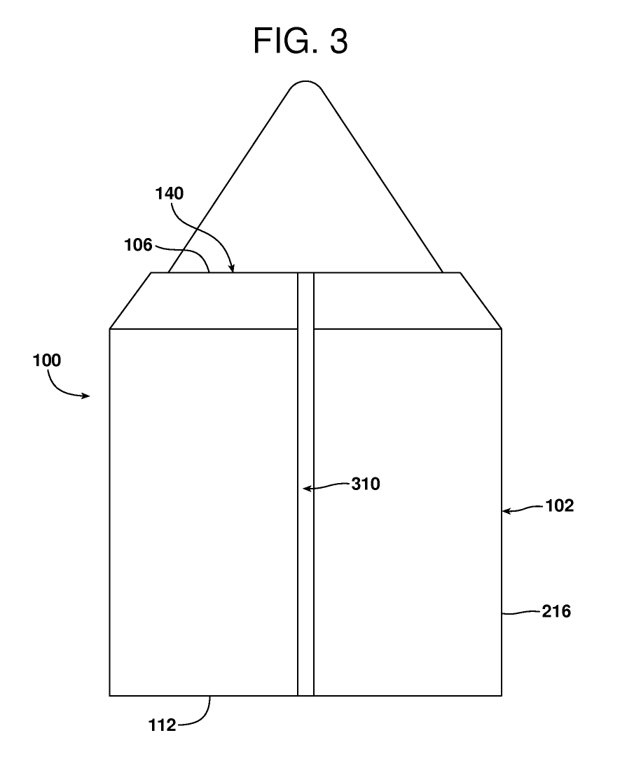

As shown in FIG. 3, the sleeve 102 may further include a slit 310 so that a braze metal may be inserted into the slit in order to fill the slit and connect both sides of the sleeve 102. The slit 310 may further extend from the proximal end 112 to the distal end 106 in such a way that the sleeve 102 may be clamped tightly against the compact 104.

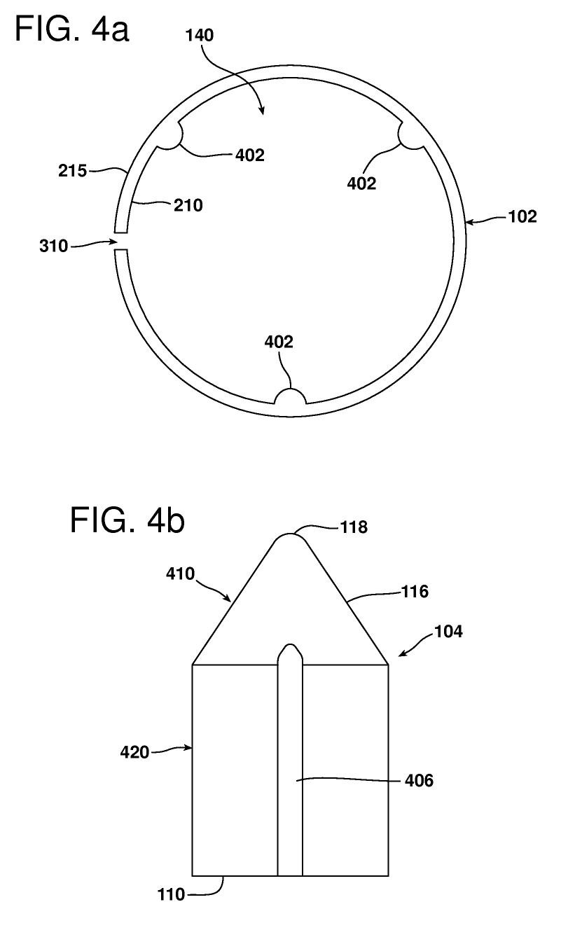

Referring to FIG. 4a, the sleeve 102 may further include a plurality of ridges 402, extending from the proximal end 112 to the distal end 106 of the sleeve 102. The slit 310 may extend from outside surface 216 of the sleeve 102 to an inner wall 210 of the bore 140.

Referring to FIG. 4b, the compact 104 may further have a plurality of grooves 406 on its surface to accommodate the plurality of ridges 402 of the inner wall 210 in such a way that the compact 104 may not be turned or rotated inside the bore 140 of the sleeve 102. The compact 104 has a cone 410 and a cylinder 420. The cylinder 420 may have a base end 110 and a top end 430. The grooves 406 may extend from the top end 430 to the base end 110. There may be a chamfer (not shown) around the periphery of the base end 110. The chamfer may have a 45 degree angle and about 1 mm in width, for example. The sleeve 104 may have a radius on the bottom corner or it may be matched at about 45 degrees to accommodate the chamfer of the compact 104. The chamfer of the compact 104 may be made to prevent the bottom corner of the compact 104 from coming into contact with the sleeve 102, which may cause very high localized stress and damages to the compact.

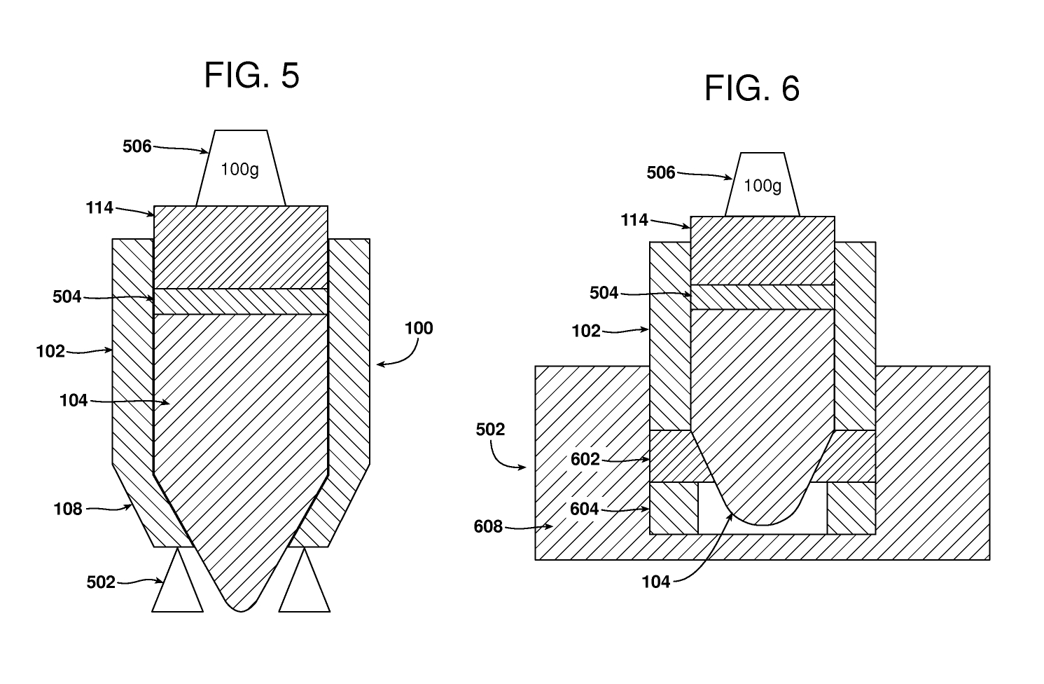

FIG. 5 shows another embodiment of a tool 100. The tool 100 may comprise a sleeve 102 and a polycrystalline diamond composite 104. The tool 100 may further include a plug 114 and a support 502 for the sleeve 102. The sleeve 102 may further include an angled part 108. The angled part 108 may conform to the contour of the compact 104. A braze metal 504 may be inserted between the plug 114 and the compact 104, such as polycrystalline diamond composite. A removable weight 506 may be put on at a top of the plug 114 for brazing process. The plug 114 and sleeve 102 may be made of carbide, such as tungsten carbide. The compact 104 may be formed of a material selected from the group consisting of cubic boron nitride, diamond, diamond composite, ceramics, boron carbide, and silicon carbide. The tool 100 may be incorporated in at least one of a drill bit, a shear bit, a percussion bit, a roller cone bit, a mining pick, a trenching pick, an road planing pick, an excavating pick, a mill, a hammer mill, a cone crusher, a jaw crusher, and a shaft impactor.

Referring to FIG. 6, the sleeve 104 may be straight walled hollow carbide cylinder, such as tungsten carbide. The support 502 may further include a first ring 602 with a cone with an inner diameter, a second ring 604, and a base 608 with holes machined. The first ring 602, the second ring 604, and the base 608 may be made of a sacrificial material which may be capable of withstanding brazing process temperatures, such as graphite. The support 502 may help to align the compact, such as polycrystalline diamond composite 104 and the sleeve 102 so that the axis for compact and axis for the sleeve may coincide.

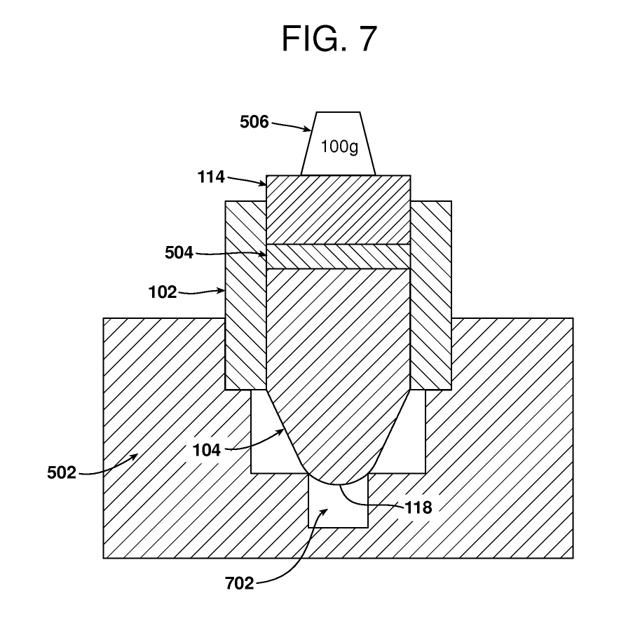

FIG. 7 refers to another embodiment of the support 502. The support 502 may be one piece and may be machined in such a way that a part of the radiused tip 118 of the compact 104 falls into a machined hole 702.

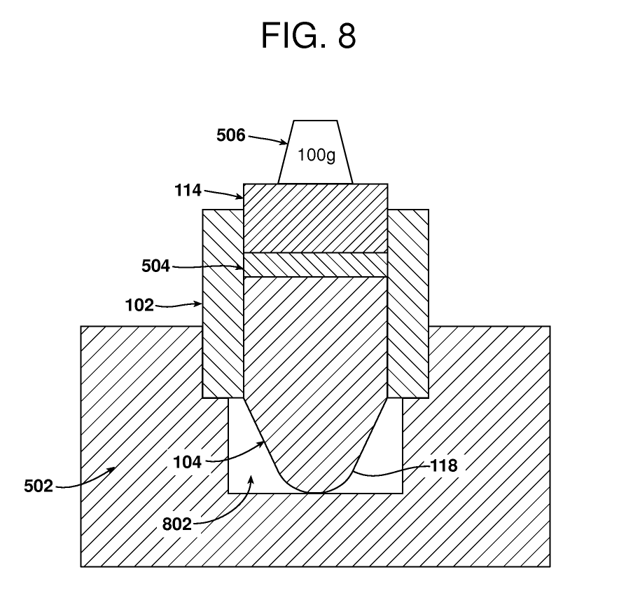

As shown in FIG. 8, the support 502 may be one piece and may be machined in such a way that the radiused tip 118 of the compact 104 substantially falls into a machined hole 802 and outside of the bore 140.

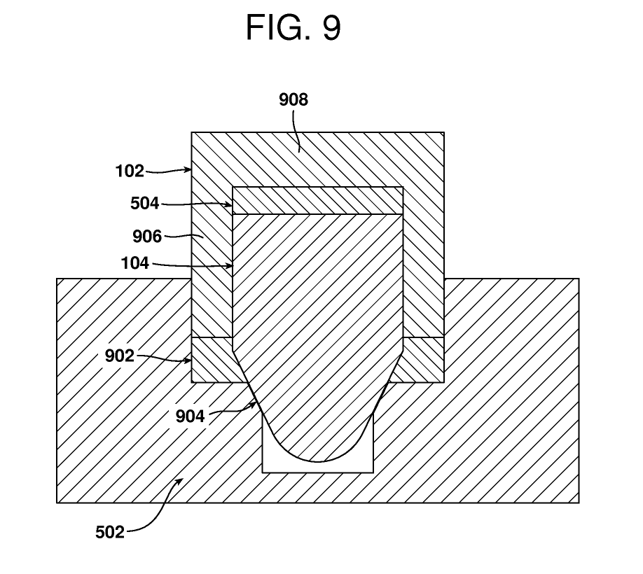

As shown in FIG. 9, the sleeve 102 may be made of one piece and look like a cup. The sleeve 102 may further comprise straight wall 906 and a bottom 908. By using the cup configuration of the sleeve 102 may eliminate the use of a plug. The support 502 may include a hole 902 and an angled section 904 so that the compact 104 may fit the sleeve 102 and the support 502 to maintain the alignment.

The hole 902 under the sleeve 102 may allow the sleeve 102 to sink onto the compact 104 during braze melting and flowing.

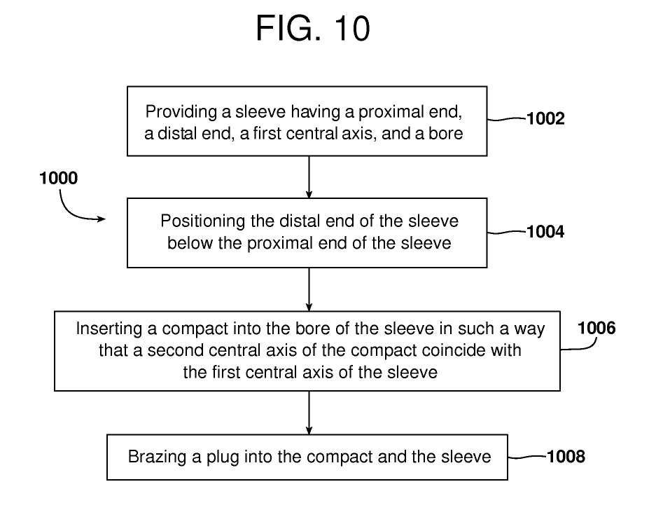

Referring to FIG. 10, a method 1000 of making a tool may comprise steps of providing a sleeve having a proximal end, a distal end, a first central axis, and a bore in a step 1002; positioning the proximal end of the sleeve above the distal end of the sleeve in a step 1004; inserting a compact into the bore of the sleeve in such a way that a second central axis of the compact coincide with the first central axis of the sleeve in a step 1006; and brazing a plug into the compact and the sleeve in a step 1008.

The method 1000 of making a tool further include steps providing a plug on top of the braze metal; adding a weight on top of the plug; providing a support for the sleeve; heating an assembly including the sleeve, the compact, the support and the braze metal. Before the compact is inserted into the bore of the sleeve, the compact may be coated at least a layer of a metal or metal carbide, such as chromium or chromium carbide, or a mixture of metal and metal carbide. The metal coating may be useful for achieving wetting between the braze metal and compact surface. The metal coating may be deposited by chemical vapor deposition (CVD), physical vapor deposition (PVD), thermal diffusion, electroplating, electroless plating, etc.

While reference has been made to specific embodiments, it is apparent that other embodiments and variations can be devised by others skilled in the art without departing from their spirit and scope. The appended claims are intended to be construed to include all such embodiments and equivalent variations.

### EXAMPLE 1

A prototype mining tool was produced using the following method. A mining tool tip was produced from VERSIMAX® silicon carbide bonded diamond composite. The tip had an overall height of 0.710 inches, a cone angle of 74.5 deg., and a diameter of 0.4675 inches. Before brazing the VERSIMAX® tip, a less than 1 micron thick Cr coating was applied using a CVD process. The coated tip had a diameter of 0.468 inches. A WC sleeve similar to the one pictured in FIG. 2b was produced having an inner diameter of 0.472 inches and an angled section matching the angle of the Versimax tip. Brazing flux (White Flux, Harris Stay-silv) was applied to the inside of the WC sleeve and the outside of the Versimax tip. The tip was inserted into the sleeve and placed on supports with the tip in the downward position as shown in FIG. 5. Fifteen braze discs (Lucas Milhaupt Braze 495) measuring 0.466 inches in diameter and 0.005 inches in thickness were coated with brazing flux and placed on top of the base of the Versimax tip. A WC plug measuring 0.470 inches in diameter and 0.240 inches in thickness was coated with brazing flux placed on top of the stack of braze discs. The assembly was heated in air to approximately 700 degrees ° C. using an induction coil, melting the braze. During the time when the braze was liquid, light pressure was applied to the WC plug to push it down inside the sleeve. After cooling, the tool was cut using wire EDM to examine the braze joint thickness in two locations. A braze joint thickness of at least 0.0015 inches was maintained around the entire diameter. 0.350 inches from the tip, the joint varied between 0.0020 and 0.0067 inches thick. 0.630 inches from the tip, the joint varied between 0.0015 and 0.0037 inches thick.

We claim:

1. A tool comprising:
a sleeve having a proximal end, a distal end, a central axis, and a bore extending from about the proximal end to about the distal end, the bore having an inner wall; and
a compact having a base end and an impact surface spaced opposite to the base end, wherein the compact is substantially disposed within the bore of the sleeve, wherein the proximal end of the sleeve is disposed proximate the base end of the compact.

2. The tool of the claim 1, wherein the bore of the sleeve has an angled part.

3. The tool of the claim 1, further comprising a plug attached to the proximal end of the sleeve and the base end of the compact.

4. The tool of the claim 1, wherein the inner wall has a plurality of ridges extending from the proximal end to the distal end of the sleeve.

5. The tool of the claim 4, wherein the compact has a plurality of grooves to accommodate the plurality of ridges of the inner wall.

6. The tool of claim 1, wherein the impact surface has a radiused tip.

7. The tool of claim 6, wherein the radiused tip is substantially outside of the bore.

8. The tool of claim 1, wherein the compact is formed of a material selected from the group consisting of cubic boron nitride, diamond, diamond composite, ceramics, silicon carbide, and boron carbide.

9. The tool of the claim 1, wherein the tool is incorporated in at least one of a drill bit, a shear bit, a percussion bit, a roller cone bit, a mining pick, a trenching pick, an road planing pick, an excavating pick, a mill, a hammer mill, a cone crusher, a jaw crusher, and a shaft impactor.

10. A method, comprising:
providing a sleeve having a proximal end, a distal end, a first central axis, and a bore;
positioning the proximal end of the sleeve above the distal end of the sleeve;
inserting a compact into the bore of the sleeve in such a way that a second central axis of the compact coincide with the first central axis of the sleeve; and
brazing a plug into the compact and the sleeve.

11. The method of the claim 10, further comprising providing a plug on top of the braze metal.

12. The method of claim 11, further comprising adding a weight on top of the plug.

13. The method of claim 10, further comprising providing a support for the sleeve.

14. The method of claim 10, further comprising heating an assembly including the sleeve, the compact and the braze metal.

15. The method of claim 10, further comprising coating the compact with at least a layer of a metal or metal carbide, or a mixture of metal and metal carbide.

16. The method of claim 13, wherein the support for the sleeve comprises a graphite base with machined holes.

17. A tool comprising:
a sleeve having a proximal end, a distal end, a first central axis, and a bore; and
a compact substantially brazed within the bore of the sleeve, wherein the compact has a second central axis, wherein the first and the second central axis coincide.

18. The tool of the claim 17, wherein the bore of the sleeve has an angled part.

19. The tool of the claim 17, wherein the compact has a base end and an impact surface spaced opposite to the base end, the proximal end is disposed proximate to the base end of the compact.

20. The tool of the claim 19, further comprising a plug attached to the base end of the compact.

21. The tool of claim 17, wherein the sleeve has a plurality of ridges extending from the proximal end to the distal end of the sleeve on an inner wall of the sleeve.

22. The tool of claim 17, further comprising a slit extending from outside surface of the sleeve to an inner wall of the bore.

23. The tool of claim 22, wherein the compact has a plurality of grooves to accommodate the plurality of ridges of the wall.

24. The tool of claim 17, wherein the compact has at least a layer of a metal or metal carbide, or a mixture of metal and metal carbide coating.
